(19) United States
(12) Patent Application Publication
(10) Pub. No.: US 2009/0047653 A1
(43) Pub. Date: Feb. 19, 2009

(54) METHOD OF INSTRUCTING USING A LEARNING CENTER

(76) Inventor: Gary L. Turner, Burley, ID (US)

Correspondence Address: ADVANTIA LAW GROUP, 9035 SOUTH 1300 EAST, SUITE 200, SANDY, UT, 84094, US

(21) Appl. No.: 12/257,195

(22) Filed: Oct. 23, 2008

Related U.S. Application Data
(63) Continuation-in-part of application No. 11/227,835, filed on Sep. 14, 2005.
(60) Provisional application No. 60/612,101, filed on Sep. 22, 2004.

(51) Int. Cl. G09B 19/00

(52) U.S. Cl. 434/433

(57) ABSTRACT

A method of instructing a plurality of students using a learning center, comprising providing a learning center, wherein the learning center includes a bench system having a two tier configuration and forming an arc of about ninety degrees. The bench system also includes a plurality of two-tier straight benches and a plurality of two-tier arcuate benches. The learning center further comprises shelves coupled to a back portion of the learning center. The method also includes providing a traditional classroom adjacent the learning center. The method further includes providing learning center rules, wherein the learning center rules include conduct rules and disciplinary rules. The method additionally includes pre-determining a single learning event at the learning center. Furthermore, the method includes holding the single learning event at the learning center following the learning center rules.

### CROSS-REFERENCE TO RELATED APPLICATIONS

This invention claims priority, under 35 U.S.C. § 120, to the U.S. Provisional Patent Application No. 60/612,101 by Turner, filed on Sep. 22, 2004, which is incorporated by reference herein. This application is a Continuation In Part Application of, under 35 U.S.C. § 121, and claims priority to, under 35 U.S.C. § 121, U.S. Non-Provisional application Ser. No. 11/227,835, entitled Instructional Center, by Turner, filed on Sep. 14, 2005.

### BACKGROUND OF THE INVENTION

1. Field of the Invention

The present invention relates to methods of instructing, specifically to a method of instructing using a learning center.

2. Description of the Related Art

Schoolteachers use various methods of teaching students. Perhaps one of the greatest challenges for schoolteachers, particularly, those teachers teaching elementary school, kindergarten, and preschool, is effectively teaching all students at the same time. This challenge becomes more and more difficult for large classrooms with high student counts. It has been observed that the proximity of students to the teacher allows early detection of learning and/or behavioral problems.

In large classrooms, with students sitting at desks oriented in rows, columns, circles, tables, groups, etc., it is difficult to effectively teach all of the students at the same time. Due to the size of the desks, and the room required between desks, a number of students are unfortunately pushed into the back of the room. Other students are forced to the side of the room. The most fortunate students are positioned near the front and center of the room where the teacher's voice is clearly understood, where students can easily see and view teaching lessons on the chalk or grease boards, and where the students are generally more well behaved.

Some schools have made use of portable seating systems that allow the students to sit in a generally semi-circular configuration around a central area of focus, which is generally the teacher. Unfortunately, due to the mobile nature of the portable seating systems, they may only be used for a short period of time, they are heavy, generally compact in size, unstable, very expensive, not a practical use of space, and appear unattractive in relation to the rest of the classroom. Some improvements have been made in the field. Examples of references related to the present invention are described below, and the supported teachings of each reference are incorporated by reference herein:

U.S. Pat. No. 5,357,876, issued to Kniefel et al., discloses a portable riser unit for supporting persons or objects above the ground, a floor, a stage or the like. The riser broadly comprises a base, generally rectangular step members, and hinge joints for pivotally, hingedly connecting the step members to the base. The base has an integrally formed, convoluted internal or interior support and baffle wall structure and may be filled with an appropriate low density, high volume material. Each step member also may be of this construction; however, the step members may or may not have an internal support wall. The step members are operably coupled to the base by double axis hinges including hinge blocks received in complementary hinge wells in the base and step members. The hinges are self-leveling to present a substantially smooth, level riser support surface in every possible configuration. The riser may be molded of a plastic material and includes integral hand grips to facilitate moving step members or the entire riser. By manipulating the step members, the riser may be re-shaped into a variety of operable configurations. The invention also encompasses connector keys for connecting two or more risers into a riser assembly.

U.S. Pat. No. 3,974,894, issued to Wenger et al., discloses a portable riser having a plurality of steps which have a travel position in superimposed relation with structure for rolling the riser along the floor, hinge means interconnecting the steps whereby they may be folded out of superimposed relation, a pair of sliders pivotally associated with each step and which are hinged to sliders of an adjacent step by said hinge means whereby lifting of one step causes erection of the riser to an erected position, and latch means automatically operable to prevent movement of the steps beyond erected position and to lock the riser in erected position for use.

U.S. Pat. No. 5,901,505, issued to Dettmann et al., discloses a portable riser, wherein the choral riser disclosed in this patent is adapted to be supported on a stage surface. The choral riser has a base that presents two spaced apart base supports, each of the base support having a first and a second spaced apart pivot point. A first step member has a step pivot point and a base pivot point that is operably pivotally coupled at the base pivot point to the base at the base first pivot point and has at least one step presented thereon. A second step member has a step pivot point and a link pivot point that is operably pivotally coupled at the step pivot point to the first step member at the first step member step pivot point and has a plurality of steps presented thereon. A bar link member is operably pivotally coupled at a first end pivot point to the second step member bar link pivot point. The bar link member is operably pivotally coupled at a second end pivot point to the base second pivot point. The first and second step members are pivotable between a stowed configuration, with at least one of the steps of the first step member facing at least one of the steps of the second step member, and an operational configuration in which the steps of the first and second step members present an ascending succession of steps. The steps are readily reversible to change the stage presentation form.

The inventions heretofore known suffer from a number of disadvantages which include being difficult to use, being limited in application, being limited in versatility, being limited in adaptability, being expensive, being ineffective, being inefficient, and being unappealing

What is needed is a method of instructing using a learning center that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available methods of instructing using a learning center. Accordingly, the present invention has been developed to provide an effective, efficient, and appealing method of instructing using a learning center.

In one embodiment of the invention, there is a method of instructing a plurality of students using a learning center. The method may include providing a learning center, wherein the learning center is facing a wall. The learning center may include a bench system having a two tier configuration and forming an arc of about ninety degrees. The bench system may also include a plurality of two-tier straight benches and a plurality of two-tier arcuate benches. The two-tier arcuate benches may each provide an angular change of about thirty degrees. The learning center may further include a plurality of shelves coupled to a back portion of the learning center.

The method of instruction may include a traditional classroom adjacent the learning center. The method may also include a single entrance formed between the wall and the bench system. The method further includes providing learning center rules comprising conduct rules. The learning center may also include disciplinary rules; wherein the disciplinary rules may include an instructor identifying a lack of respect for the learning center as a place of privilege by a student and issues a warning. The method of instruction may additionally include pre-determining a single learning event at the learning center. Then, the method includes holding the single learning event at the learning center following the learning center rules.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematic representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a top plan view of a classroom having a learning center, according to one embodiment of the invention;

FIG. 2 is a top plan view of a classroom having a learning center, according to one embodiment of the invention;

FIG. 3 is a rear perspective view of a learning center, according to one embodiment of the invention; and

FIG. 4 is a flow chart of a method of instructing using a learning center, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

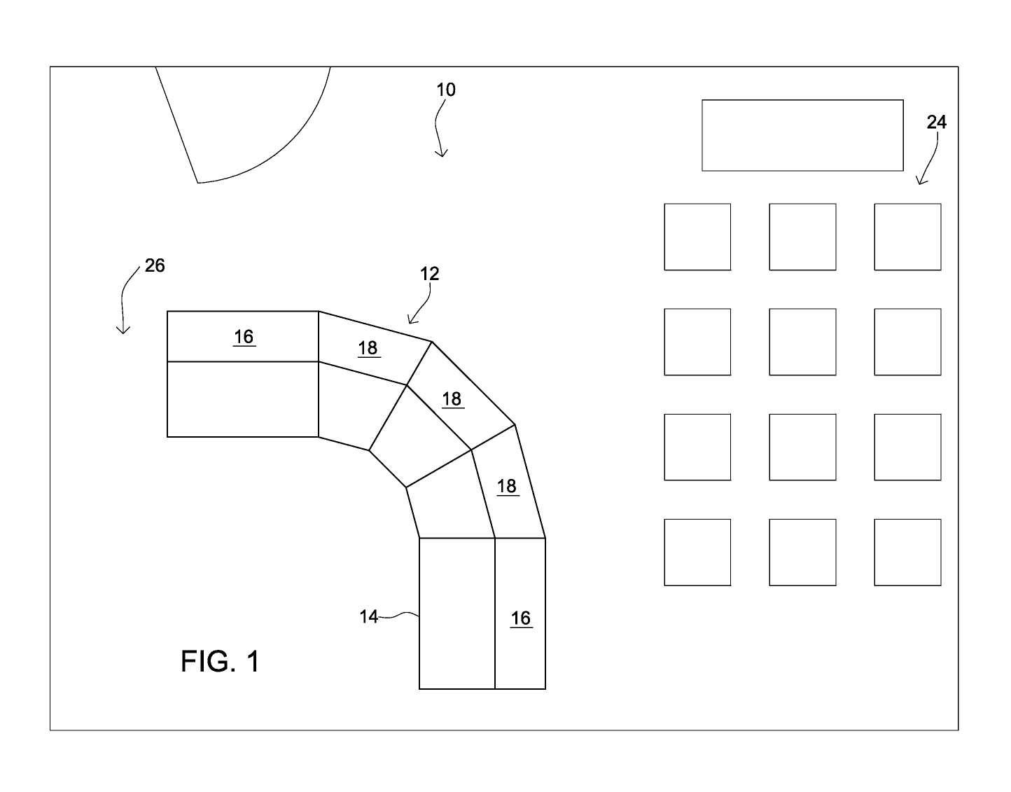

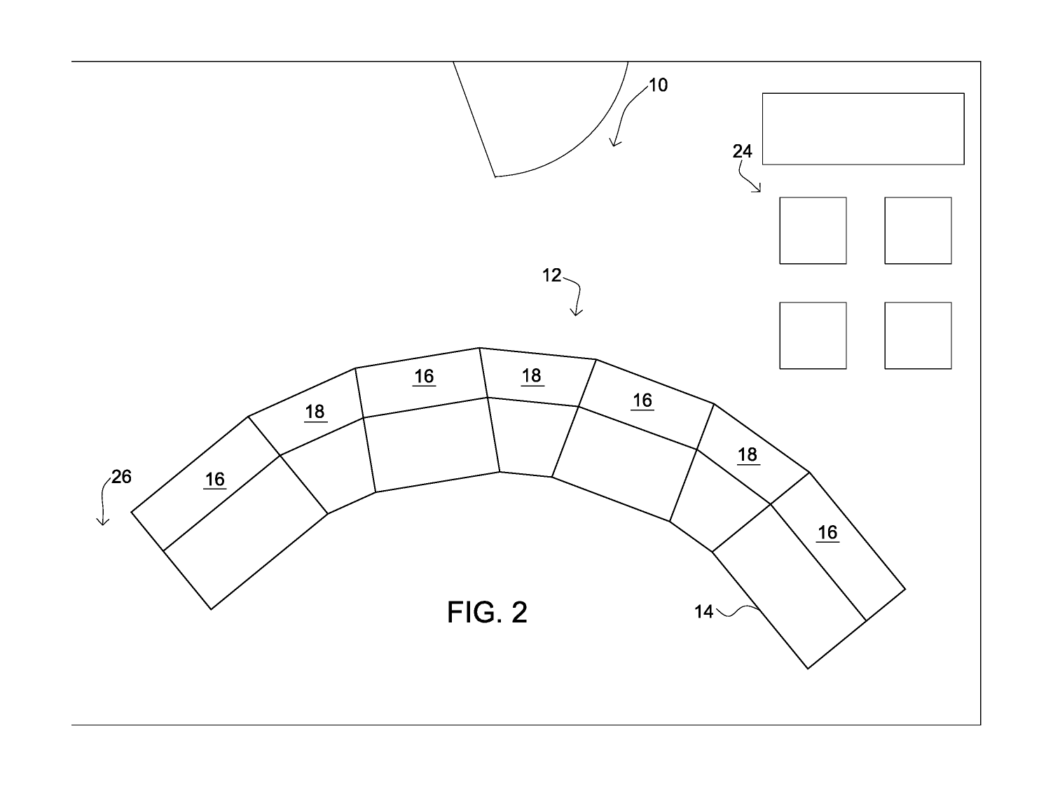

FIG. 1 illustrates a top plan view of a classroom having a learning center 12, wherein the learning center 12 is facing a wall. The learning center 12 includes a bench system 14 having a two tier configuration and forming an arc of about ninety degrees. The bench system 14 includes a plurality of two-tier straight benches 16 and a plurality of two-tier arcuate benches 18. The two-tier arcuate benches 18 each provide an angular change of about thirty degrees. As illustrated in FIGS. 1 and 2, the method of instructing a plurality of students 10 includes providing a traditional classroom 24 adjacent the learning center 12. The learning center 12 includes a single entrance 26 formed between the wall and the bench system 14.

As illustrated in FIG. 1, the bench system 14 includes a plurality of arcuate benches 18, wherein the plurality of arcuate benches 18 are disposed about a center of the bench system 14 in succession. The arcuate benches 18 include a straight bench 16 extending from both sides of the arcuate benches 18, thereby forming an arc of about ninety degrees. The ninety degree configuration of the bench system 14 is configured to center the attention of the students to the instructor positioned in front of the learning center 12.

FIG. 2 illustrates a classroom having a learning center 12, according to one embodiment of the invention, wherein the learning center 12 includes a bench system 14 having a plurality of two-tier straight benches 16 and a plurality of two-tier arcuate benches 18. As illustrated in FIG. 2, the straight benches 16 and the arcuate benches 18 alternate in configuration, wherein there is a straight bench 16 then an arcuate bench 18, thereby forming an arc of about ninety degrees. The ninety degree configuration of the bench system 14 is configured to center the attention of the students to the instructor positioned in front of the learning center 12. In addition, FIG. 2 also illustrates the bench system 14 configured to face a single wall, instead of a corner as illustrated in FIG. 1.

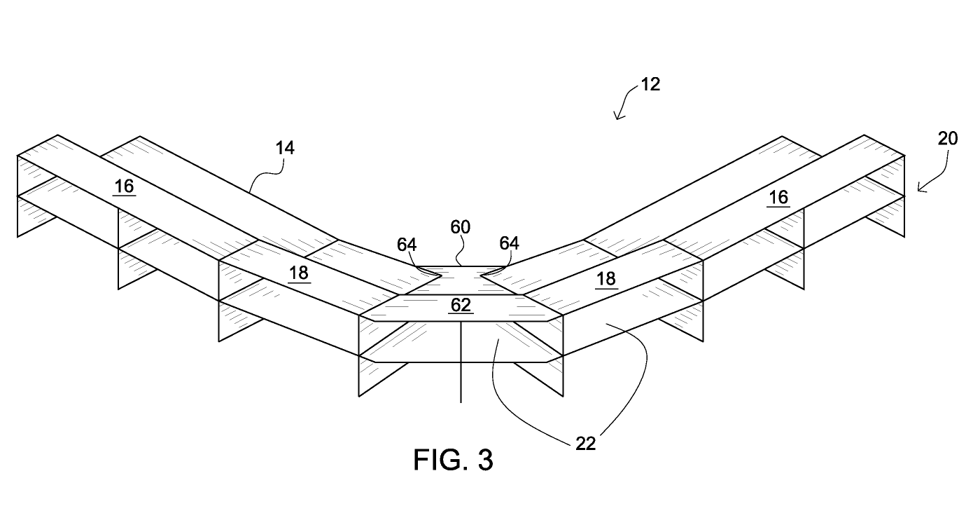

FIG. 3 illustrates a learning center 12, according to one embodiment of the invention, wherein the learning center 12 includes a bench system 14 having a plurality of two-tier straight benches 16 and a plurality of two-tier arcuate benches 18. As illustrated in FIG. 3, the learning center 12 includes a plurality of shelves 20 coupled to a back portion 22 of the learning center 12, wherein students and/or instructors store instructing tools. Also illustrated in FIG. 3, the bench system 14 includes a central arcuate bench 62, wherein the central arcuate bench 62 includes a securing member 60 disposed about both sides of the central arcuate bench 62. The straight or arcuate benches coupling either side of the securing member 60 of the central arcuate bench 62 includes a surface 64 configured to secure to the securing member 60 of the central arcuate bench 62, thereby securing the bench system together.

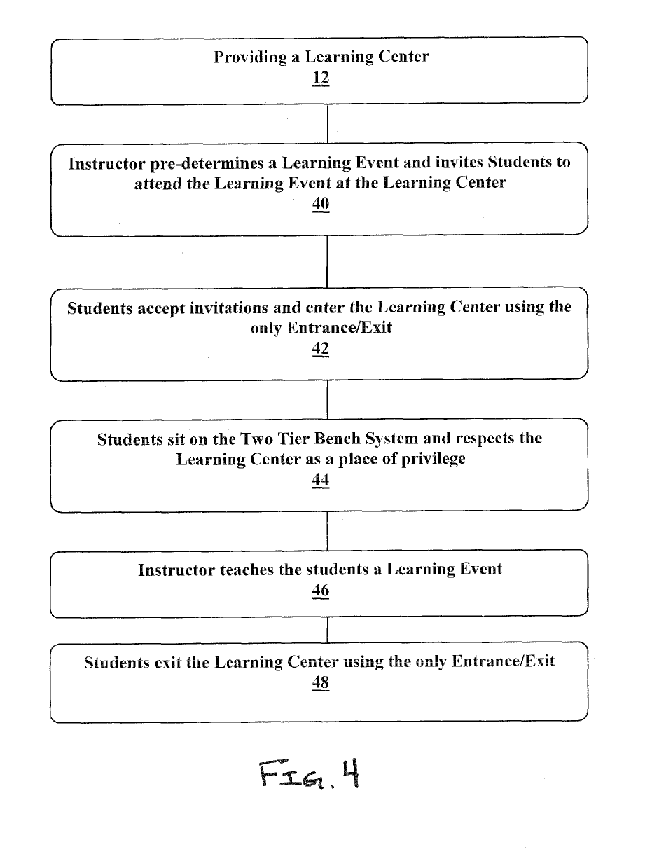

FIG. 4 illustrates a method of instructing a plurality of students 10 using a learning center 12, according to one embodiment of the invention, wherein the method 10 includes providing a learning center 12. Then the method includes an instructor predetermining a learning event and inviting students to attend the learning event at the learning center 40. Accordingly, the students accept their invitations and enter the learning center using the only entrance/exit 42. The students sit on the bench system and respect the learning center as a place of privilege 44. Respecting the learning center as a place of privilege includes following a plurality of learning center rules, wherein the learning center rules include a plurality of conduct rules and a plurality of disciplinary rules. The instructor teaches the students a learning event at the learning center following the learning center rules 46. The students may interact and incorporate information about the learning event along with the instructor. After the learning event the students return to the classroom using the only entrance/exit to the learning center 48.

In one embodiment of the invention, the conduct rules include requiring each student to only use the single entrance 26 when entering/exiting the learning center 12. The learning center rules include if a student receives an invitation to attend a learning event at the learning center 12, then the student may attend the learning event 46. In addition, the learning center rules include, if the student respects the learning center 12 as a place of privilege, then the student may attend the learning event. However, if the student does not respect the learning center 12 as a place of privilege, then the privilege to attend a learning event 46 may be taken away. Furthermore, if the student brings unnecessary items to the learning center 12, then the student will be asked to remove the unnecessary items from the learning event 12.

The disciplinary rules include, an instructor identifying a lack of respect for the learning center 12 as a place of privilege by a student and issues a warning. If an instructor issues a plurality of warnings to a student, the student will be ejected from the learning center 12. After an ejection the student must get permission to return to the learning center for a learning center event. The student is not allowed in the learning center, unless given an invitation to the learning event at the learning center by the instructor.

In operation of one embodiment of the invention, an instructor predetermines a learning event and invites students to attend the learning event at the learning center. Then the students that accept their invitations enter the learning center using the only entrance/exit to attend the learning event. The students sit on the bench system and respect the learning center as a place of privilege. Respecting the learning center as a place of privilege includes following a plurality of learning center rules, wherein the learning center rules include a plurality of conduct rules and a plurality of disciplinary rules. The instructor then teaches the students a learning event at the learning center following the learning center rules. After the learning event the students return to the classroom using the only entrance/exit to the learning center 48.

In operation of one embodiment of the invention, if the student does not respect the learning center 12 as a place of privilege, then the privilege to attend a learning event may be taken away. Furthermore, if the student brings unnecessary items to the learning center 12, then the student will be asked to remove the unnecessary items from the learning event 12. Furthermore, if an instructor identifies a lack of respect for the learning center 12 as a place of privilege by a student, the instructor issues a warning. If an instructor issues a plurality of warnings to a student, the student will be ejected from the learning center 12. After an ejection the student must get permission to return to the learning center for a learning center event. The student is not allowed in the learning center until given an invitation to the learning event at the learning center of the instructor.

In operation of one embodiment of the invention, the learning center may be used to focus the attention of students with learning disabilities, perception problems, or cognitive problems; wherein the learning center creates an environment that promotes discussion and interaction with one another, student and instructor alike. In addition, the learning center presents everyone to be on the same eye level, thereby creating a relaxed environment for students and instructors to interact with each other about a particular learning event. Furthermore, the learning event and the learning center create an expectation to the students that when there is a short learning event; it allows people at the learning event to be focused and able to participate in a discussion about a particular topic.

The short period of time of the learning events enables students with disabilities or learning problems to be able to focus and interact with others in a relaxed environment with learning center rules that create a level forum to present information to a group of peers. The more experience with the learning center as a forum to present ideas and information enable students and instructors to develop social skills that a normal classroom setting is unable to provide. Discussion amongst peers in a controlled environment promotes social growth when peers are not under a controlled environment, thereby creating more self confidence to students or instructors with social interaction problems. The learning center enhances the learning experience by creating a safe environment for reluctant students to express and interact with other students and instructors in an organized manner. In addition, students with anxiety, while speaking, will also benefit from the safe learning environment the learning center creates.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a ninety degree configuration of the bench system, one skilled in the art would appreciate that the bench system may vary in size, shape, design, configuration, color, orientation, disposition, length, width, height, and still perform its intended function. A non-limiting example may be that the plurality of arcuate benches and the plurality of straight benches may vary in angle, size, shape, design, configuration, length, depth, height, and still perform its intended function.

Additionally, although the figures illustrate a learning center disposed adjacent to a classroom, one skilled in the art would appreciate that the learning center may be disposed about a plurality of teaching institutions. Non-limiting examples may be, but not limited to, libraries, study halls, auditoriums, concert halls, learning disability centers, lecture halls, elementary schools, middle schools, high schools, colleges, universities, etc., and still perform its intended function. In addition, the learning center also may be disposed about a plurality of non-teaching institutions such as, but not limited to, prisons, counseling centers, rehab centers, disability centers, etc. and still perform its intended function.

It is envisioned that one skilled in the art would appreciate that the learning center may also be a staging area for student or instructor presentations. The student or instructor may prepare and then present a lesson plan or a brief presentation.

It is also envisioned that one skilled in the art would appreciate that the plurality of shelves, coupled to a back portion of the learning center, may include a plurality of locking doors, wherein the instruction tools may be secured and stored within the plurality of shelves.

Furthermore, although the figures illustrate a plurality of shelves coupled to a back portion of the learning center, one skilled in the art would appreciate that the lower shelve may be a pull out drawer configured to store instructing tools.

Finally, it is envisioned that the components of the device may be constructed of a variety of materials, non-limiting examples may be metal, metal alloys, wood, plastic, rubber, rubber composite, plastic composite, etc., and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of, or to consist essentially of, one or more of the features, functions, structures, methods described herein.

What is claimed is:

1. A method of instructing a plurality of students using a learning center, comprising:
a) providing a learning center facing a wall and comprising:
1) a bench system having a two tier configuration and forming an arc of about ninety degrees, wherein the bench system includes a plurality of two-tier straight benches and a plurality of two-tier arcuate benches; and
2) a single entrance formed between the wall and the bench system;
b) providing learning center rules, comprising:
b1) conduct rules; and
b2) disciplinary rules;
c) predetermining a single learning event at the learning center; and
d) holding the single learning event at the learning center following the learning center rules.

2. The method of claim 1, wherein the two-tier arcuate benches each provide an angular change of about thirty degrees.

3. The method of claim 1, wherein learning center further comprises shelves coupled to a back portion of the learning center.

4. The method of claim 1, wherein conduct rules includes requiring student to only use the single entrance when entering/exiting the learning center.

5. The method of claim 1, wherein the conduct rules includes only entering/exiting the learning center on invitation.

6. The learning center of claim 1, further comprising providing a traditional classroom adjacent the learning center.

7. The method of claim 1, wherein the conduct rules include:
a) if a student receives an invitation to attend a learning event at the learning center, then the student may attend the learning event;
b) if the student respects the learning center as a place of privilege, then the student may attend learning events;
c) if the student does not respect the learning center as a place of privilege, then the privilege to attend a learning event may be taken away; and
d) if the student brings unnecessary items to the learning center, then the student will be asked to remove the unnecessary items from the learning event.

8. The method of claim 1, wherein the disciplinary rules include:
a) an instructor identifying a lack of respect for the learning center as a place of privilege by a student and issues a warning;
b) if an instructor issues a plurality of warnings to a student, the student will be ejected from the learning center; and
c) the student is not allowed in the learning center until given an invitation to the learning event at the learning center of the instructor.

9. The method of claim 1, wherein the bench system includes a straight bench and a arcuate bench alternating in configuration.

10. The method of claim 1, wherein the bench system includes a plurality of arcuate benches disposed about a center of the bench system having a straight bench extending from both sides of the arcuate benches.

11. A method of instructing a plurality of students using a learning center, comprising:
a) providing a learning center facing a wall and comprising:
1) a bench system having a two tier configuration and forming an arc of about ninety degrees, wherein the bench system includes a plurality of two-tier straight benches and a plurality of two-tier arcuate benches; wherein learning center further comprises shelves coupled to a back portion of the learning center;
2) a traditional classroom adjacent the learning center; and
3) a single entrance formed between the wall and the bench system;
b) providing learning center rules, comprising:
b1) conduct rules; and
b2) disciplinary rules;
c) predetermining a single learning event at the learning center; and
d) holding the single learning event at the learning center following the learning center rules.

12. The method of claim 11, wherein the two-tier arcuate benches each provide an angular change of about thirty degrees.

13. The method of claim 12, wherein conduct rules includes requiring student to only use the single entrance when entering/exiting the learning center.

14. The method of claim 13, wherein the conduct rules includes only entering/exiting the learning center on invitation.

15. The method of claim 14, wherein the conduct rules include:
a) if a student receives an invitation to attend a learning event at the learning center, then the student may attend the learning event;
b) if the student respects the learning center as a place of privilege, then the student may attend learning events;
c) if the student does not respect the learning center as a place of privilege, then the privilege to attend a learning event may be taken away; and
d) if the student brings unnecessary items to the learning center, then the student will be asked to remove the unnecessary items from the learning event.

16. The method of claim 15, wherein the disciplinary rules include:
a) an instructor identifying a lack of respect for the learning center as a place of privilege by a student and issues a warning;
b) if an instructor issues a plurality of warnings to a student, the student will be ejected from the learning center; and
c) the student is not allowed in the learning center until given an invitation to the learning event at the learning center of the instructor.

17. The method of claim 16, wherein the bench system includes a straight bench and a arcuate bench alternating in configuration.

18. The method of claim 16, wherein the bench system includes a plurality of arcuate benches disposed about a center of the bench system having a straight bench extending from both sides of the arcuate benches.

19. A system of instructing a plurality of students using a learning center, comprising:
a) providing a learning center facing a wall and comprising:
1) a bench system having a two tier configuration and forming an arc of about ninety degrees, wherein the bench system includes a plurality of two-tier straight benches and a plurality of two-tier arcuate benches; wherein the two-tier arcuate benches each provide an angular change of about thirty degrees; wherein learning center further comprises shelves coupled to a back portion of the learning center; wherein the bench system includes a straight bench and a arcuate bench alternating in configuration;
2) a traditional classroom adjacent the learning center; and
3) a single entrance formed between the wall and the bench system;
b) providing learning center rules, comprising:
b1) conduct rules; wherein conduct rules includes requiring student to only use the single entrance when entering/exiting the learning center; wherein the conduct rules includes only entering/exiting the learning center on invitation; wherein the conduct rules further include:
b11) if a student receives an invitation to attend a learning event at the learning center, then the student may attend the learning event;
b12) if the student respects the learning center as a place of privilege, then the student may attend learning events;
b13) if the student does not respect the learning center as a place of privilege, then the privilege to attend a learning event may be taken away; and
b14) if the student brings unnecessary items to the learning center, then the student will be asked to remove the unnecessary items from the learning event and
b2) disciplinary rules; wherein the disciplinary rules include:
b21) an instructor identifying a lack of respect for the learning center as a place of privilege by a student and issues a warning;
b22) if an instructor issues a plurality of warnings to a student, the student will be ejected from the learning center; and
b23) the student is not allowed in the learning center until given an invitation to the learning event at the learning center of the instructor;
c) predetermining a single learning event at the learning center; and
d) holding the single learning event at the learning center following the learning center rules.

20. The system of claim 19, wherein the bench system includes a plurality of arcuate benches disposed about a center of the bench system having a straight bench extending from both sides of the arcuate benches.
